(19) United States
(12) Patent Application Publication
(10) Pub. No.: US 2004/0174395 A1
(43) Pub. Date: Sep. 9, 2004

(54) Tablet personal computer having functions of switching keyboards and display data

(76) Inventor: Jefferson Liu, Taichung (TW)

Correspondence Address: PRO-TECHTOR INTERNATIONAL, 20775 Norada Court, Saratoga, CA, 95070-3018, US

(21) Appl. No.: 10/382,315

(22) Filed: Mar. 4, 2003

(51) Int. Cl. G09G 5/00

(52) U.S. Cl. 345/773

(57) ABSTRACT

A tablet personal computer having functions of switching keyboards and display data comprises the following elements. A touch liquid crystal display has a function of receiving input signals from an electronic pen. A motherboard is electrically connected to the touch liquid crystal display. A switched keyboard key-in module serves for displaying a virtual keyboard layout on the touch liquid crystal display so as to key-in data by using an electronic pen or by typewriting by fingers; and for transferring the display content of the touch liquid crystal display from a wireless AV signals transmitting device to a wireless AV signals receiving device. The wireless AV signals transmitting device serves for receiving the display contents of the touch liquid crystal display and transmitting the display content wirelessly; and the wireless AV signals receiving device serves to receive the wireless signals and transfer the display content to a large scale of display.

### FIELD OF THE INVENTION

The present invention relates to tablet personal computers, and particularly to a tablet personal computer having functions of switching keyboards and display data.

### BACKGROUND OF THE INVENTION

FIG. 1 is a schematic view of a conventional tablet personal computer. The conventional tablet personal computer 10 has a touch liquid crystal display 103 which can receive input signals from an electronic pen 101. A motherboard 105 (not shown) is electrically connected to the touch liquid crystal display 103. This conventional tablet personal computer 10 is a portable and easily key-in device. Since this kinds of computer must be compact and has a small size, it is only equipped with a small liquid crystal display, it is unsuitable to key-in data to the computer by electronic pens so that the conventional tablet personal computer is not as convenient as a desk top computer.

### SUMMARY OF THE INVENTION

Accordingly, the primary object of the present invention is to provide a tablet personal computer having functions of switching keyboards and display data, which comprise the following elements. A touch liquid crystal display has a function of receiving input signals from an electronic pen. A motherboard is electrically connected to the touch liquid crystal display. A switched keyboard key-in module serves for displaying a virtual keyboard layout on the touch liquid crystal display so as to key-in data by using an electronic pen or by typewriting by fingers; and for transferring the display content of the touch liquid crystal display from a wireless AV signals transmitting device to a wireless AV signals receiving device. The wireless AV signals transmitting device serves for receiving the display contents of the touch liquid crystal display and transmitting the display content wirelessly; and the wireless AV signals receiving device serves to receive the wireless signals and transfer the display content to a large scale of display.

The various objects and advantages of the present invention will be more readily understood from the following detailed description when read in conjunction with the appended drawing.

### BRIEF DESCRIPTION OF THE DRAWINGS

FIG. 1 is a schematic view of a conventional tablet personal computer.

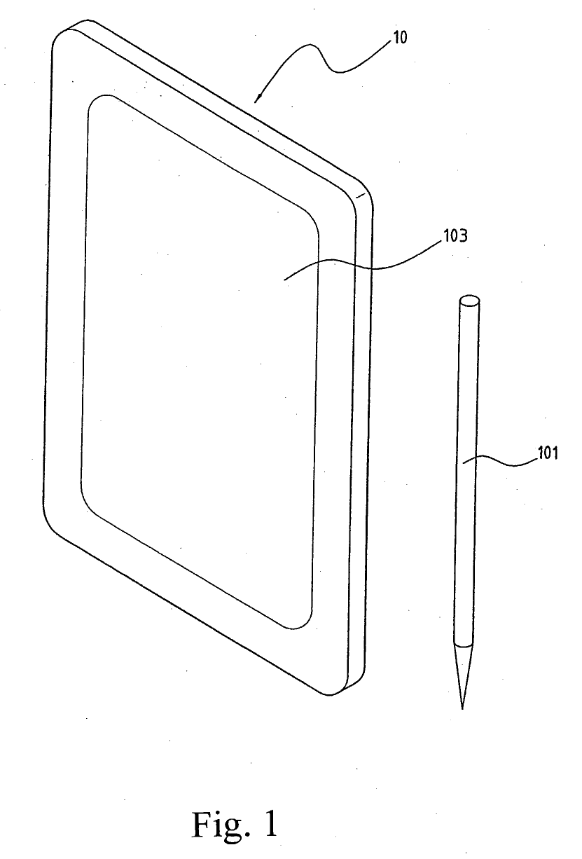

FIG. 2 is a schematic view of the tablet personal computer of the present invention.

FIG. 3 is a structural schematic view of the tablet personal computer shown in FIG. 2.

FIG. 4 is a schematic view of the tablet personal computer in the switched keyboard key-in module.

### DETAILED DESCRIPTION OF THE PREFERRED EMBODIMENTS

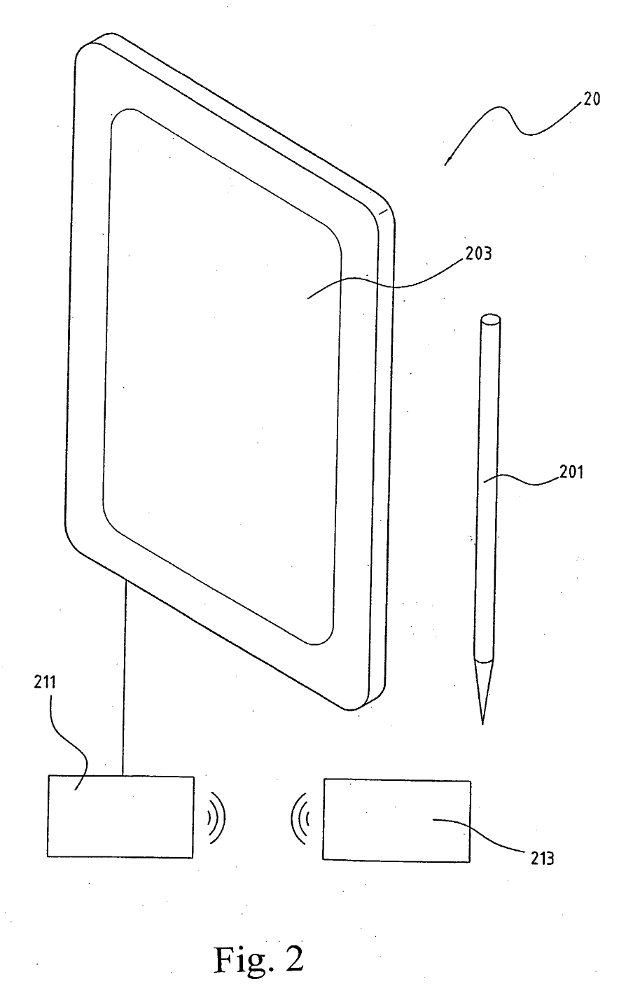

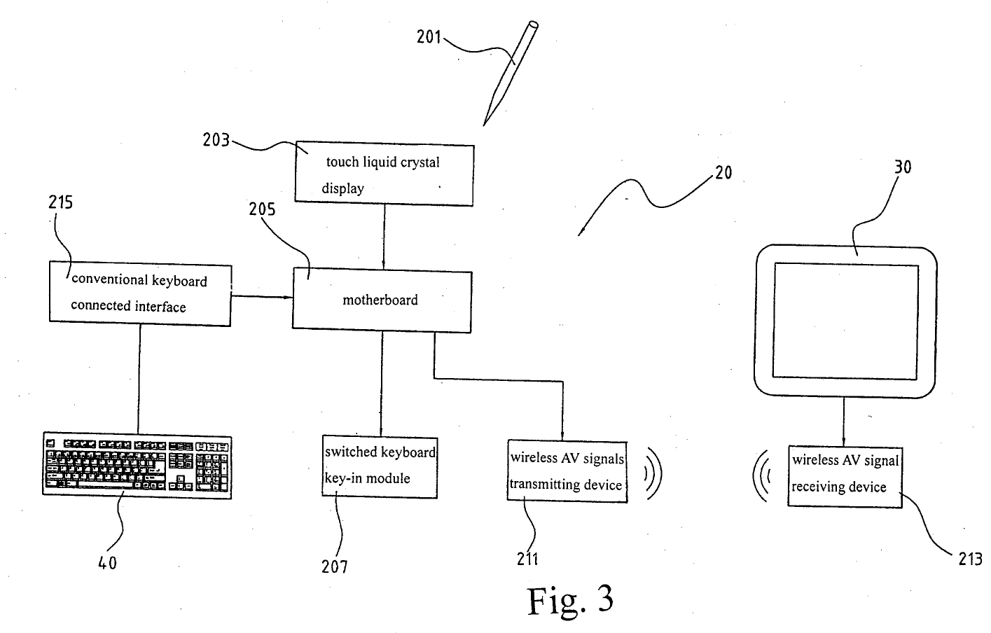

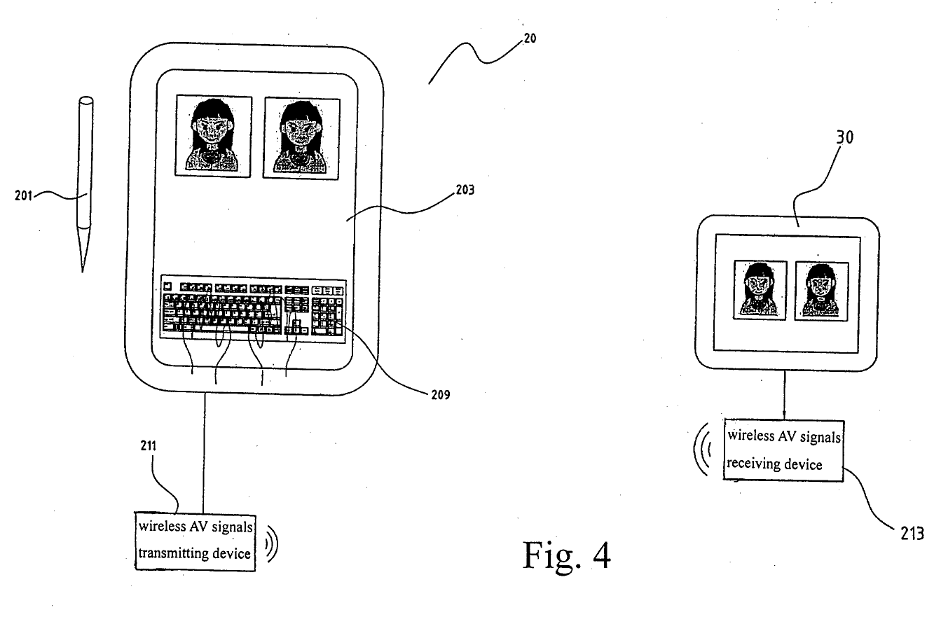

Referring to FIGS. 2, the schematic view of the present invention is illustrated. The tablet personal computer 20 includes a touch liquid crystal display 203 having a function of receiving input signals from an electronic pen 201; a motherboard 205 electrically connected to the touch liquid crystal display 203 (referring to FIG. 3); a switched keyboard key-in module 207 (referring to FIG. 3) for displaying a virtual keyboard layout 209 (referring to FIG. 4) to the touch liquid crystal display 203 and for transferring the display content of the touch liquid crystal display 203 from the wireless AV signals transmitting device 211 to the wireless AV signals receiving device 213. The wireless AV signals transmitting device 211 serves for receiving the display contents of the touch liquid crystal display 203 and transmitting the display content wirelessly. The wireless AV signals receiving device 213 serves to receive the wireless signals and transfer the display content to a large scale of display 30 (referring to FIG. 3). The wireless AV signals transmitting device 211 of the present invention can be separated from or combined with the tablet personal computer 20. When the wireless AV signals transmitting device 211 is separated from the tablet personal computer 20, the use thereof is the same as to use a conventional tablet personal computer 10. Namely, at this condition, the tablet personal computer 20 is used as a conventional tablet personal computer 20.

The structural schematic view of the tablet personal computer 20 of FIG. 2 is illustrated in FIG. 3. Referring to FIG. 3, the touch liquid crystal display 203 is electrically connected to the motherboard 205 and serves for receiving the input signals of the electronic pen 201. The motherboard 205 is electrically connected to the wireless AV signals transmitting device 211. The wireless AV signals receiving device 213 receives signals from the wireless AV signals transmitting device 211 and transfers the contents of the signals to the large scale display 30.

With reference to FIG. 4, it is shown that the tablet personal computer 20 is operated in the switched keyboard key-in module 207. The touch liquid crystal display 203 displays a virtual keyboard layout 209 for providing the different key-in functions by electronic pens or fingers. The large scale of display 30 displays the contents of the touch liquid crystal display 203 and emit related voices.

In the present invention, the tablet personal computer 20 further comprises a conventional keyboard connected interface 215 for being connected to a conventional keyboard 40 for replacing the key-in function of the electronic pen 201. Thereby, the user of the tablet personal computer 20 can key-in data by the conventional keyboard 40.

The large size display 30 may be a television or a cathode ray tube display or other display.

The tablet personal computer 20 of the present invention has the following advantages.

Firstly, when the use selects the function of the switched keyboard key-in module 207, other than the touch liquid crystal display 203, by the wireless AV signals transmitting device 211 and wireless AV signals receiving device 213, the display contents can be displayed to the large scale of display 30. Moreover, the user may use the virtual keyboard layout 209 on the touch liquid crystal display 203 as an electronic pen or key-in data by touch of fingers.

The tablet personal computer 20 of the present invention extends to the function of the conventional tablet personal computer 10 so that it can be connected to the conventional keyboard 40 for replacing the key-in function of the electronic pen 201.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A tablet personal computer having functions of switching keyboards and display data comprising:
a touch liquid crystal display having a function of receiving input signals from an electronic pen;
a motherboard electrically connected to the touch liquid crystal display;
a switched keyboard key-in module for displaying a virtual keyboard layout on the touch liquid crystal display so as to key-in data by using an electronic pen or by typewriting by fingers; and for transferring the display content of the touch liquid crystal display from a wireless AV signals transmitting device to a wireless AV signals receiving device;
wherein the wireless AV signals transmitting device serves for receiving the display contents of the touch liquid crystal display and transmitting the display content wirelessly; and
the wireless AV signals receiving device serves to receive the wireless signals and transfer the display content to a large scale of display.

2. The tablet personal computer as claimed in claim 1, wherein the large scale of display is a television.

3. The tablet personal computer as claimed in claim 1, wherein the large scale of display is a cathodes ray tube monitor or other display monitor.

4. The as claimed in claim 1, further comprising a conventional keyboard connecting interface for being connected to a conventional keyboard.
